(19) United States
(12) Patent Application Publication
(10) Pub. No.: US 2026/0019119 A1
(43) Pub. Date: Jan. 15, 2026

(54) COMPLEMENTARY INFORMATION REPORT FOR PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/992,143

(22) PCT Filed: Aug. 20, 2022
(86) PCT No.: PCT/CN2022/113787

§ 371 Date: Jan. 7, 2025

(51) Int. Cl. H04B 7/06; H04B 17/318; H04L 41/16

(52) U.S. Cl. CPC H04B 7/0626; H04B 17/328; H04L 41/16

(57) ABSTRACT

Aspects of the present disclosure relate to artificial intelligence/machine learning (AI/ML) beam management system in millimeter wave (mmW) wireless communications systems for beam prediction to communicate between base station and user equipment (UE). The beam management system may utilize a plurality of complimentary channel state information (CSI) reports transmitted from the UE to the base station within a time domain (TD) window that compliments persistent or semi-persistent CSI-reports to improve the confidence level of the beam predictions by the AI/ML beam management system.

### BACKGROUND

### Technical Field

The present disclosure generally relates to communication systems, and more particularly, to implementing complementary information report for predictive beam management.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Therefore, there exists a need for further improvements in 5G NR technology. These improvements may also be applicable to other multi-access technologies and the telecommunication standards that employ these technologies. For instance, improvements to efficiency and latency relating to mobility of UEs communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. Aspects of the present disclosure relate to artificial intelligence/machine learning (AI/ML) beam management system in millimeter wave (mmW) wireless communications systems for beam prediction to communicate between base station and user equipment (UE). The beam management system may utilize a plurality of complimentary channel state information (CSI) reports transmitted from the UE to the base station within a time domain (TD) window that compliments persistent or semi-persistent CSI-reports to improve the confidence level of the beam predictions by the AI/ML beam management system.

In an example aspect includes a method of wireless communication by a base station, comprising receiving, at the base station, a plurality of complimentary channel state information (CSI) reports from a user equipment (UE) for a time division (TD) window that provides channel characteristics for a set of beams at multiple instance of times within the TD window. The method further comprising processing the plurality of complimentary CSI reports to generate beam predictions using artificial intelligence (AI) and machine learning (ML) beam management models.

Another example aspect includes an apparatus for wireless communication by a base station, comprising a memory that includes instructions executable by a processor coupled with the memory. The instructions executable by the processor to receive, at the base station, a plurality of complimentary CSI reports from a UE for a TD window that provides channel characteristics for a set of beams at multiple instance of times within the TD window. The instructions executable by the processor to process the plurality of complimentary CSI reports to generate beam predictions using AI and ML beam management models.

Another example includes an apparatus for wireless communication by a base station, comprising means for receiving, at the base station, a plurality of complimentary CSI reports from a UE for a TD window that provides channel characteristics for a set of beams at multiple instance of times within the TD window. The apparatus further comprising means for processing the plurality of complimentary CSI reports to generate beam predictions using AI and ML beam management models.

Another example includes a non-transitory computer readable medium storing instructions, executable by a processor, for wireless communications. The instructions, executable by the processor, include instructions for receiving, at a base station, a plurality of complimentary CSI reports from a UE for a TD window that provides channel characteristics for a set of beams at multiple instance of times within the TD window. The instructions further for processing the plurality of complimentary CSI reports to generate beam predictions using AI and ML beam management models.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network in accordance with various aspects of the present disclosure.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a timing diagram illustrating the P/SP CSI-report for each TD window along with the generation and reporting of one or more complementary reports that include channel characteristics with improved TD granularity in accordance with various aspects of the present disclosure.

FIG. 4 is a diagram illustrating an example of the spatial domain correlation reports that may be included as part of the complementary reports transmitted by the UE to the base station in accordance with various aspects of the present disclosure.

FIG. 5 is a schematic diagram of an example implementation of various components of a user equipment in accordance with various aspects of the present disclosure.

FIG. 6 is a flow diagram of an example of a method of wireless communication implemented by the UE in accordance with aspects of the present disclosure.

FIG. 7 is a schematic diagram of an example implementation of various components of a base station in accordance with various aspects of the present disclosure.

FIG. 8 is a flow diagram of an example of a method of wireless communication implemented by the base station in accordance with aspects of the present disclosure.

### DETAILED DESCRIPTION

Millimeter wave (mmW) systems enable a wide range of applications. However, there are a number of challenges with mmW systems, including the use of a narrow beam and the sensitivity of mmW signals to blockage that impact the coverage and reliability for mobile UEs. Identifying the optimal beamforming vectors in large antenna array in mmW system also requires considerable overhead that significantly affect the efficiency of wireless communication systems.

To this end, Artificial Intelligence/Machine Learning (AI/ML) models for beam management may be utilized for beam prediction in time domain (TD), spatial domain (SD), and/or frequency domain (FD) for overhead and latency reduction. The AI/ML models for beam management also provide improved beam selection accuracy. And in order to predict future downlink (DL) transmitter (Tx) beam qualities, the UE may perform channel measurements for a set of beams and provide feedback information to the base station.

In some examples, the AI/ML-based beam management system may support spatial-domain DL beam prediction for a first set of beams (e.g., Set A of beams) based on measurement results of second set of beams (e.g., Set B of beams). Additionally or alternatively, the AI/ML-based beam management may also support temporal DL beam prediction for a first set of beams (e.g., Set A of beams) based on historic measurement results of second set of beams (e.g., Set B of beams). In some examples, the second set of beams (e.g., Set B of beams) may be a subset of the first set of beams (e.g., Set A of beams). In other examples, the first set (e.g., Set A) and second set (e.g., Set B) of beams may be different. For example, Set A may consist of narrow beams and Set B may consist of wide beams. Additionally or alternatively, Set A of beams may be for downlink beam prediction and Set B may be for DL mean measurement.

As noted above, in order for the AI/ML-based beam management system to accurately generate beam predictions in TD, SD, and/or FD for communication with the UE, the UE may persistently (or semi-persistently) transmit a channel state information (CSI) report based on the measurements of the one or more beams. The persistent (P) or semi-persistent (SP) CSI-reports may be transmitted from the UE to the base station at the conclusion of each TD window. But the P/SP CSI-reports captures the state of the channel and the set of beams at the instance that the UE conducts the channel measurements and reports the P/SP CSI-report to the base station. The TD window may be, for example, 20 milliseconds (ms) or longer (or shorter). And the mmW beams, as noted above, may be extremely sensitive to blockage that impacts the coverage and reliability. Thus, in some instances, the P/SP CSI-report received at the base station from the UE at the end of each TD window capturing the state of the channel when the UE measurement was conducted may not accurately capture the state of the channel during the past TD window. And such deviations may impact the confidence level of the AI/ML-based beam management system to accurately predict the beamforming vectors for communications with the UE.

Indeed, low confidence of base station beam predication results may be due to insufficient TD observations reported from the UE to the base station (e.g., TD down-sampling may be too aggressive) or sudden interference that could not have been fully delivered to the base station from the UE (e.g., also due to TD down-sampled reports). Thus, the lack of granular information regarding the channel state of the beams within the TD window may be problematic where the base station beam management system may have predicted upcoming beam change or blockage based on P/SP CSI-report, but the confidence level in such blockage was low.

Accordingly, channel observations measured by the UE with better TD granularity with respect to past TD window that may be additionally available for the base station may improve the confidence level for the AI/ML-based beam management system. For example, when L1-signal to noise ratios (SINRs) variation status regarding a past TD window is additionally available, the base station may further verify whether the predicted beam blockage is due to upcoming blockage or a false positive due to some instantaneous interference that may have occurred at the time the P/SP CSI-report measurement was conducted. But constantly reporting such detailed information from the UE to the base station may also consume too much uplink (UL) overhead or UE power. Thus, the base station may request the UE to prepare such reports on a limited basis if the base station determines an increasing number of low-confidence predictions. Accordingly, aspects of the present disclosure provide techniques for determining when to transmit the additional reports from the UE to the base station within the TD window that balances the overhead and resource requirements of the UE to perform, store, and transmit additional measurements against the requirements of the base station AI/ML-based beam management system for accurate beam predictions and reduced overhead and latency.

Additionally, techniques disclosed herein provide the additional information (e.g., complementary L1 reports) that include channel characteristics (e.g., TD L1-reference signal received power (RSRP) or L1-SINR variation, or SD correlations of the L1-RSRP/L1-SINR variations) with improved TD granularity than a single P/SP CSI-report for each TD window. Thus, in some examples, one or more complimentary L1 reports that measure the channel state of the set of beams within the past TD window may supplement the P/SP CSI report provided by the UE to the base station at the conclusion of each TD window. The additional complimentary L1 reports received by the base station may assist the base station AI/ML-based beam management system improve the confidence level of the beam prediction model. In some examples, the complimentary L1 reports may be based on medium access control-control element (MAC-CE) or access point (AP) CSI-Reports, where AP-CSI-Reports based solution may provide more flexibility and allows on-demand UE preparation/memorizing of the better TD granularity observations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

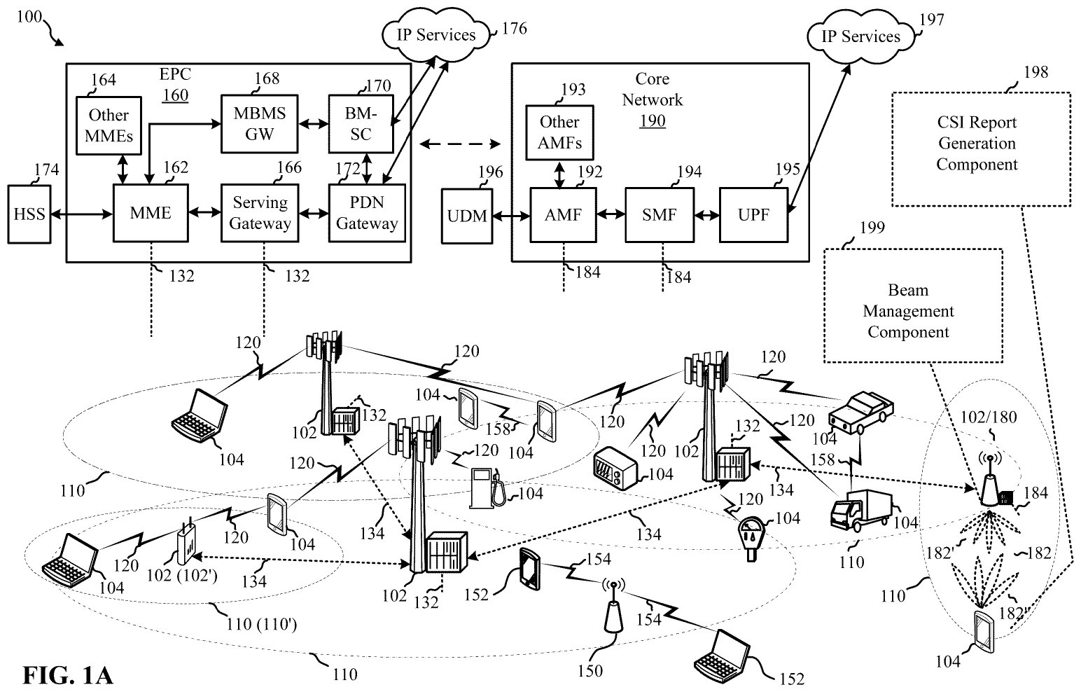

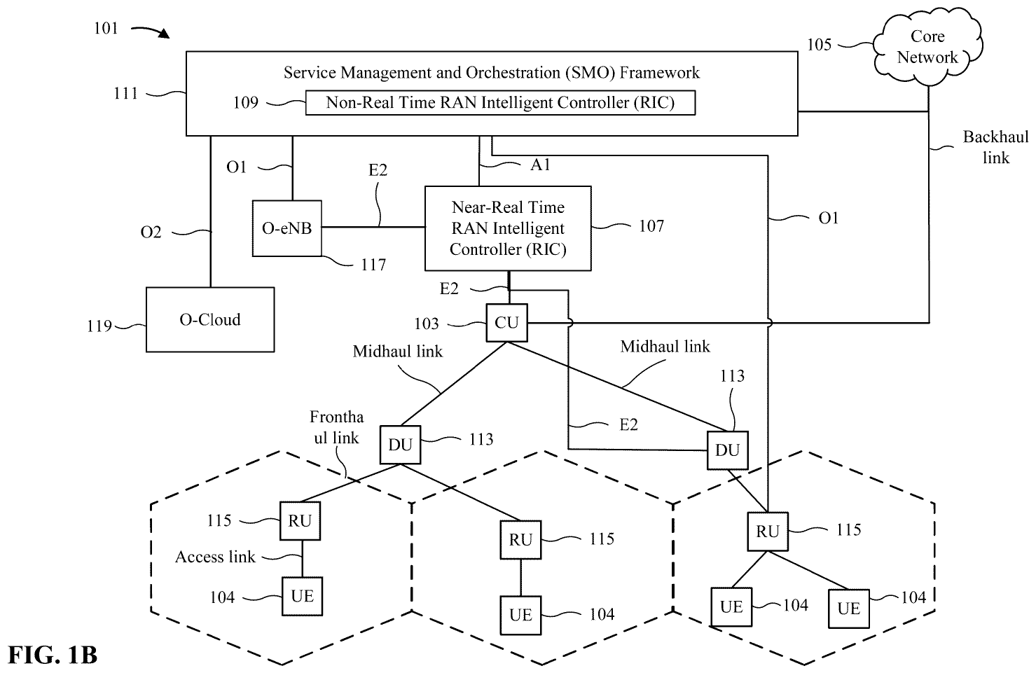

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UEs 104 may include a CSI report generation component 198 to perform the functions disclosed herein, including generating additional information (e.g., complementary L1 reports) that include channel characteristics (e.g., TD L1-RSRP or L1-SINR variation, or SD correlations of the L1-RSRP/L1-SINR variations) with improved TD granularity than P/SP CSI-reports that are transmitted by the UE for each TD window. Thus, in some examples, the CSI report generation component 198 may generate and transmit both the one or more complimentary L1 reports that measure the channel state of the set of beams within the past TD window and the P/SP CSI report that are provided by the UE to the base station at the conclusion of each TD window. In some examples, the one or more complimentary L1 reports may supplement or provide additional information that provide insight into the channel state for the beams within the past TD window that may not be available in the P/SP CSI-reports generated for transmission at the conclusion of each TD window.

The one or more base stations may also include a beam management component 199 for receiving the P/SP CSI-reports from the UE at the conclusion of each TD windows. In addition, the beam management component 199 may receive (or request) one or more complimentary L1 reports that measure the channel state of the set of beams within the past TD window. The beam management component 199 may utilize the one or more complimentary L1 reports to assist the base station AI/ML-based beam management system improve the confidence level of the beam prediction model.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHZ-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band. With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an Al interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as Al policies).

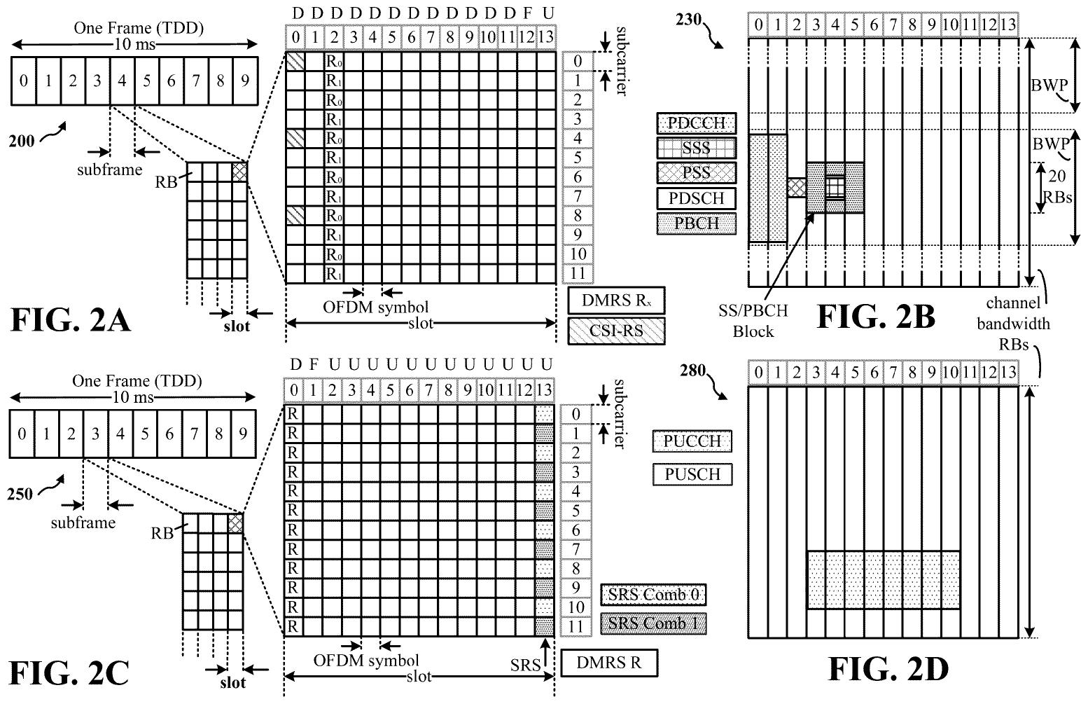

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

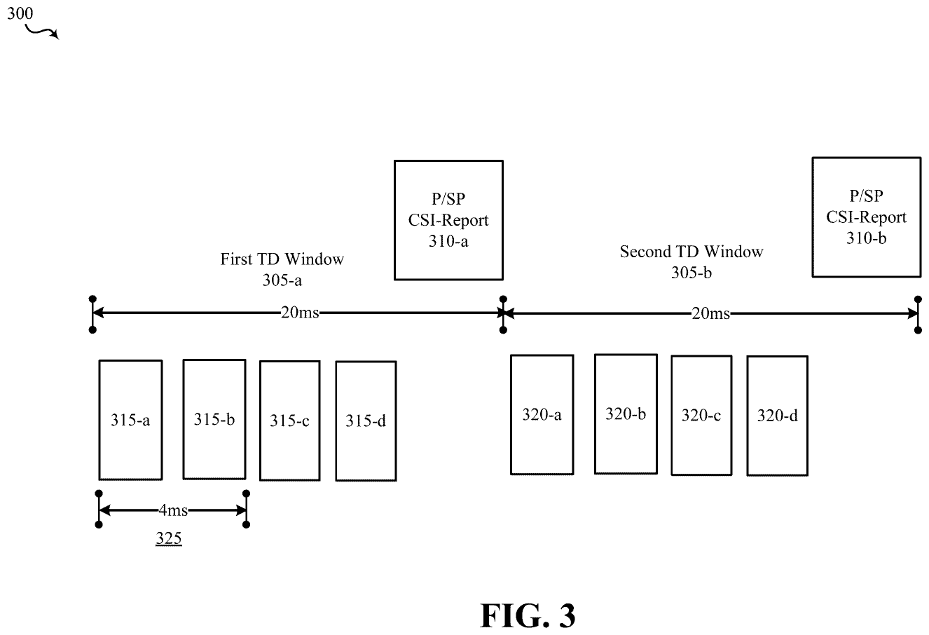

FIG. 3 is a timing diagram 300 of the P/SP CSI-reporting 310 for each TD window 305 along with the generation and reporting of one or more complementary reports 315 that include channel characteristics with improved TD granularity in accordance with various aspects of the present disclosure. As discussed above, for the AI/ML-based beam management system located at the base station to accurately generate beam predictions in TD, SD, and/or FD for communication with the UE, the base station may need feedback regarding the channel measurements from the UEs.

To this end, the UE may transmit a P/SP CSI-report 310 approximate to or at the end of each TD window 305 (e.g., one or more last symbols for transmission opportunity within the TD window 305). Although in the illustrated example, the TD window 305 is shown as 20 ms, a person of ordinary skill would appreciate that the TD window 305 can be modified to different time periods. In some examples, a TD window may be equal to one or more of the reporting periodicity of a P/SP CSI report 310. The specific number of periodicities may be further configured by the base station or predefined.

The P/SP CSI-reports 310 received at the base station from the UE at the end of each TD window 305 capture the state of the channel at the instant of time when the UE measurement was conducted, and therefore may not accurately capture any deviations that may have occurred at different periods within the TD window 305. But such deviations may impact the confidence level of the AI/ML-based beam management system. Low confidence of base station beam predication results may be due to insufficient TD observations reported from the UE to the base station (e.g., TD down-sampling may be too aggressive) or sudden interference that could not have been fully delivered to the base station from the UE (e.g., also due to TD down-sampled reports).

Thus, techniques disclosed herein provide the additional information (e.g., complementary L1 reports 315) for the TD window 305 that include channel characteristics (e.g., TD L1-RSRP or L1-SINR variation, or SD correlations of the L1-RSRP/L1-SINR variations) with improved TD granularity than are available by P/SP CSI-report 310. Thus, in some examples, one or more complimentary L1 reports 315 that measure the channel state of the set of beams within the past TD window 305 may supplement the P/SP CSI report 310 provided by the UE to the base station at the conclusion of each TD window. The additional complimentary L1 reports 315 received by the base station may assist the base station AI/ML-based beam management system improve the confidence level of the beam prediction model. In some examples, the complimentary L1 reports 315 may be based on MAC-CE or AP-CSI-Reports, where AP-CSI-Reports based solution may provide more flexibility and allows on-demand UE preparation/memorizing of the better TD granularity observations.

In some examples, the UE may dynamically report complementary reports 315 regarding the past TD window 305, including the TD variation details of the measured L1-RSRPs/L1-SINRs associated with a P/SP CSI-RS resource or a synchronization signal block (SSB). Additionally, the complimentary reports 315 may also include spatial domain correlation details of the measured L1-RSRPs/L1-SINRs associated with multiple P/SP CSI-RS resources or multiple SSBs. In some examples, the channel measurement resources (CMR) and/or interference measurement resources (IMRs) associated with the P/SP CSI report 310 may be the P/SP CSI-RS resources or SSBs addressed in the complementary report 315.

In order to facilitate the generation and reporting of the complimentary reports 315, the UEs 104 may be configured with a cell-specific P-CSI-RS with a shorter periodicity 325 (e.g., 4 ms). In some examples, the UE may be configured to report the L1-RSRPs every 20 ms (e.g., as part of the P/SP CSI-Report) instead of every 4 ms in order to conserve resources. But if the base station determines that the confidence level for beam prediction as part of the AI/ML-based beam management system falls below a threshold, the base station may request the UE to transmit the L1-RSRP reports for the past TD window more frequently.

In some examples, different UEs may be requested to report over different occasions for offloading purposes. The base station may assist with predicting in the SD/TD the L1-RSRPs of the occasions that the UE that did not report. For example, the base station may predict the L1-RSRPs regarding some other refined beams that are not required to be measured or reported by the UEs.

In some examples, the one or more complimentary reports 315 that are transmitted from the UE to the base station may be detailed L1-RSRPs or L1-SINRs associated with the CSI-RSs/SSBs regarding multiple time occasions with the past TD window. In other examples, the one or more complimentary reports 315 may include TD variance (level) associated with the L1-RSRPs/L1-SINRs of the CSI-RS/SSBs within the past TD window 305. For example, considering a certain CSI-RS/SSB, the one or more complimentary reports 320 reported by the UE may include differential decibel-milliwatts (dBm) value referring to the L1-RSRP associated with the CSI-RS/SSB reported in the most recent P-CSI-report occasion 310-a. Such differential dBm value may provide information regarding the maximum difference observed by the UE during the past TD window (e.g., second TD window 305-b), comparing to the most recently reported L1-RSRP/L1-SINR in the P-CSI-Report (e.g., P/SP CSI Report 310-a).

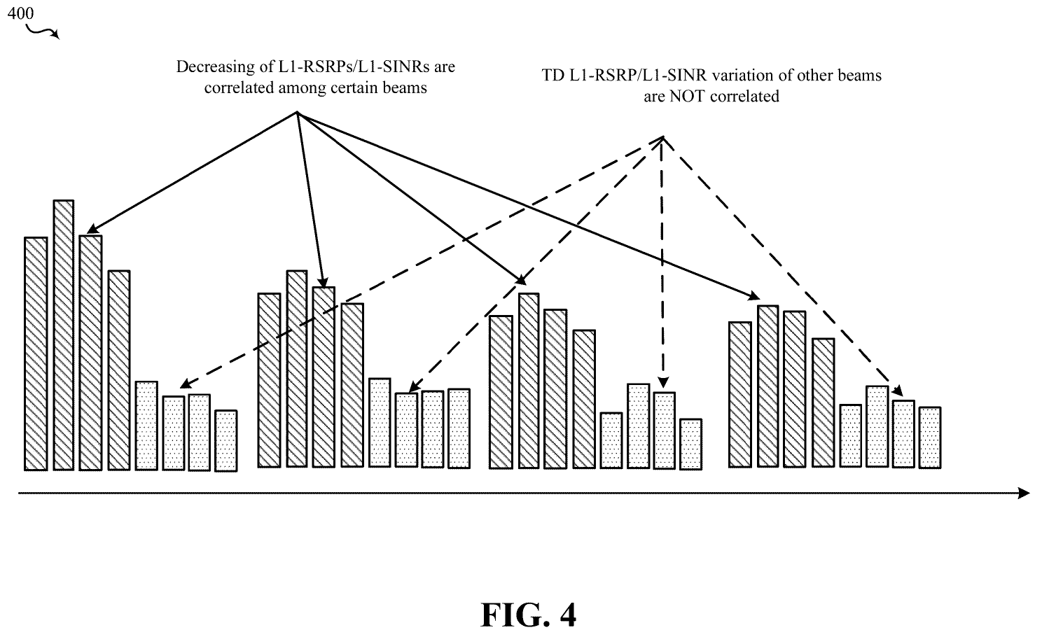

FIG. 4 is a diagram illustrating an example of the spatial domain correlation reports that may be included as part of the complementary reports transmitted by the UE to the base station in accordance with various aspects of the present disclosure. In some examples, the complementary reports (315, 320) that may be transmitted from the UE to the base station to complement or supplement the P/SP CSI reports 310 may indicate whether two or more CSI-RSs/SSBs have a certain level of correlation (e.g., due to wide-beam interference or blocker from a certain direction) in terms of L1-RSRP/L1-SINR fluctuation. Options of the correlation levels may be predefined or configured by the base station.

In some examples, the correlation levels configured by the base station may include a first level where a certain number of CSI-RSs/SSBs have all been observed to comprise decreased L1-RSRPs over the past TD window, wherein the decrease-rate for each of the considered CSI-RS/SSB is over a certain power level (e.g., over 3 dBm every 4 ms). This may be caused due to approaching blocker in a certain direction.

The correlation levels may also include a second level where no obvious decreasing or increasing L1-RSRP over the past TD window are detected for certain number of CSI-RSs/SSBs. And a third level where a certain number of CSI-RSs/SSBs have all been detected or observed to comprise increased L1-RSRPs over the past TD window, wherein the decrease-rate for each of the considered CSI-RS/SSB may be over a certain power level for particular time period (e.g., over 3 dBm every 4 ms). This may be due to departing blocker in a certain direction.

Thus, in the complimentary L1 reports (e.g., complimentary reports 315, 320), the UE may report the CSI-RS/SSB identification (ID) for each level, or report the Level-ID for each considered CSI-RS/SSB.

In other examples, the complementary reports 315/320 may be carried by the UL MAC-CE or uplink control information (UCI). For MAC-CE based reporting, the UE may transmit the one or more complementary reports 315/320 if the UE detects a TD fluctuation that exceeds a predetermined threshold or correlated enough SD variations of the considered CSI-RSs/SSBs. In such instance, the MAC-CE could be transmitted, wherein the thresholds may be configured by the base station.

With respect to UCI (e.g., AP-CSI-report) based reporting, the UE may transmit the complementary reports 315/320 based on the base station initiated request (e.g., base station requests an AP CSI report). This can be further based on including all necessary base station pre-configurations in the AP CSI triggering state configurations associated with the AP-CSI report. The UCI based reporting may also be on introducing new types of report quantities associated with AP CSI reports. Additionally or alternatively, the UCI based reporting may be based on downlink control information (DCI) requesting AP CSI report. In some examples, priority of the AP CSI reports may be lower or higher than other existing types of CSI reports.

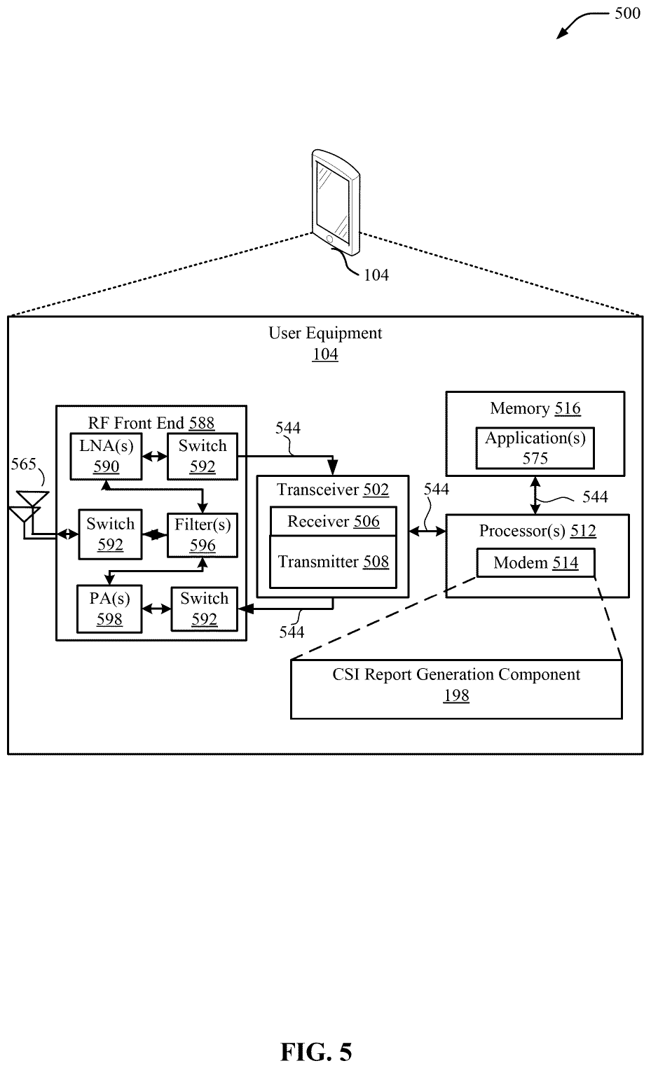

FIG. 5 illustrates a hardware components and subcomponents of a device that may be a UE 104 for implementing one or more methods (e.g., method 600) described herein in accordance with various aspects of the present disclosure. The UE 104 may be an example of UE 104 disclosed with reference to FIG. 1A. For example, one example of an implementation of the UE 104 may include a variety of components, some of which have already been described above, but including components such as one or more processors 512, memory 516 and transceiver 502 in communication via one or more buses 544, which may operate in conjunction with the CSI report generation component 198 to perform functions described herein related to including one or more methods (e.g., 600) of the present disclosure.

Particularly, the CSI report generation component 198 may perform the functions disclosed herein, including generating additional information (e.g., complementary L1 reports) that include channel characteristics (e.g., TD L1-RSRP or L1-SINR variation, or SD correlations of the L1-RSRP/L1-SINR variations) with improved TD granularity than P/SP CSI-reports that are transmitted by the UE for each TD window. Thus, in some examples, the CSI report generation component 198 may generate and transmit both the one or more complimentary L1 reports that measure the channel state of the set of beams within the past TD window and the P/SP CSI report that are provided by the UE to the base station at the conclusion of each TD window. In some examples, the one or more complimentary L1 reports may supplement or provide additional information that provide insight into the channel state for the beams within the past TD window that may not be available in the P/SP CSI-reports generated for transmission at the conclusion of each TD window.

The one or more processors 512, modem 514, memory 516, transceiver 502, RF front end 588 and one or more antennas 565, may be configured to support voice and/or data calls (simultaneously or non-simultaneously) in one or more radio access technologies. In an aspect, the one or more processors 512 can include a modem 514 that uses one or more modem processors. The various functions related to CSI report generation component 198 may be included in modem 514 and/or processors 512 and, in an aspect, can be executed by a single processor, while in other aspects, different ones of the functions may be executed by a combination of two or more different processors. For example, in an aspect, the one or more processors 512 may include any one or any combination of a modem processor, or a baseband processor, or a digital signal processor, or a transmit processor, or a receiver processor, or a transceiver processor associated with transceiver 502. In other aspects, some of the features of the one or more processors 512 and/or modem 514 associated with CSI report generation component 198 may be performed by transceiver 502.

The memory 516 may be configured to store data used herein and/or local versions of application(s) 575 or communication management component 198 and/or one or more of its subcomponents being executed by at least one processor 512. The memory 516 can include any type of computer-readable medium usable by a computer or at least one processor 512, such as random access memory (RAM), read only memory (ROM), tapes, magnetic discs, optical discs, volatile memory, non-volatile memory, and any combination thereof. In an aspect, for example, the memory 516 may be a non-transitory computer-readable storage medium that stores one or more computer-executable codes defining CSI report generation component 198 and/or one or more of its subcomponents, and/or data associated therewith, when the UE 104 is operating at least one processor 512 to execute communication management component 198 and/or one or more of its subcomponents.

The transceiver 502 may include at least one receiver 506 and at least one transmitter 508. The receiver 506 may include hardware, firmware, and/or software code executable by a processor for receiving data, the code comprising instructions and being stored in a memory (e.g., computer-readable medium). The receiver 506 may be, for example, a radio frequency (RF) receiver. In an aspect, the receiver 506 may receive signals transmitted by at least one UE 104. Additionally, receiver 506 may process such received signals, and also may obtain measurements of the signals, such as, but not limited to, Ec/Io, SNR, RSRP, RSSI, etc. The transmitter 508 may include hardware, firmware, and/or software code executable by a processor for transmitting data, the code comprising instructions and being stored in a memory (e.g., computer-readable medium). A suitable example of the transmitter 508 may including, but is not limited to, an RF transmitter.

Moreover, in an aspect, transmitting device may include the RF front end 588, which may operate in communication with one or more antennas 565 and transceiver 502 for receiving and transmitting radio transmissions, for example, wireless communications transmitted by at least one base station 102 or wireless transmissions transmitted by UE 104. The RF front end 588 may be connected to one or more antennas 565 and can include one or more low-noise amplifiers (LNAs) 590, one or more switches 592, one or more power amplifiers (PAs) 598, and one or more filters 596 for transmitting and receiving RF signals.

In an aspect, the LNA 590 can amplify a received signal at a desired output level. In an aspect, each LNA 590 may have a specified minimum and maximum gain values. In an aspect, the RF front end 588 may use one or more switches 592 to select a particular LNA 590 and its specified gain value based on a desired gain value for a particular application.

Further, for example, one or more PA(s) 598 may be used by the RF front end 588 to amplify a signal for an RF output at a desired output power level. In an aspect, each PA 598 may have specified minimum and maximum gain values. In an aspect, the RF front end 588 may use one or more switches 592 to select a particular PA 598 and its specified gain value based on a desired gain value for a particular application.

Also, for example, one or more filters 596 can be used by the RF front end 558 to filter a received signal to obtain an input RF signal. Similarly, in an aspect, for example, a respective filter 596 can be used to filter an output from a respective PA 598 to produce an output signal for transmission. In an aspect, each filter 596 can be connected to a specific LNA 590 and/or PA 598. In an aspect, the RF front end 588 can use one or more switches 592 to select a transmit or receive path using a specified filter 596, LNA 590, and/or PA 598, based on a configuration as specified by the transceiver 502 and/or processor 512.

As such, the transceiver 502 may be configured to transmit and receive wireless signals through one or more antennas 565 via the RF front end 588. In an aspect, the transceiver 502 may be tuned to operate at specified frequencies such that transmitting device can communicate with, for example, one or more base stations 102 or one or more cells associated with one or more base stations 102 or other UEs 104. In an aspect, for example, the modem 514 can configure the transceiver 502 to operate at a specified frequency and power level based on the configuration of the transmitting device and the communication protocol used by the modem 514.

In an aspect, the modem 514 can be a multiband-multimode modem, which can process digital data and communicate with the transceiver 502 such that the digital data is sent and received using the transceiver 502. In an aspect, the modem 514 can be multiband and be configured to support multiple frequency bands for a specific communications protocol. In an aspect, the modem 514 can be multimode and be configured to support multiple operating networks and communications protocols. In an aspect, the modem 514 can control one or more components of transmitting device (e.g., RF front end 588, transceiver 502) to enable transmission and/or reception of signals from the network based on a specified modem configuration. In an aspect, the modem configuration can be based on the mode of the modem 514 and the frequency band in use. In another aspect, the modem configuration can be based on UE configuration information associated with transmitting device as provided by the network during cell selection and/or cell reselection.

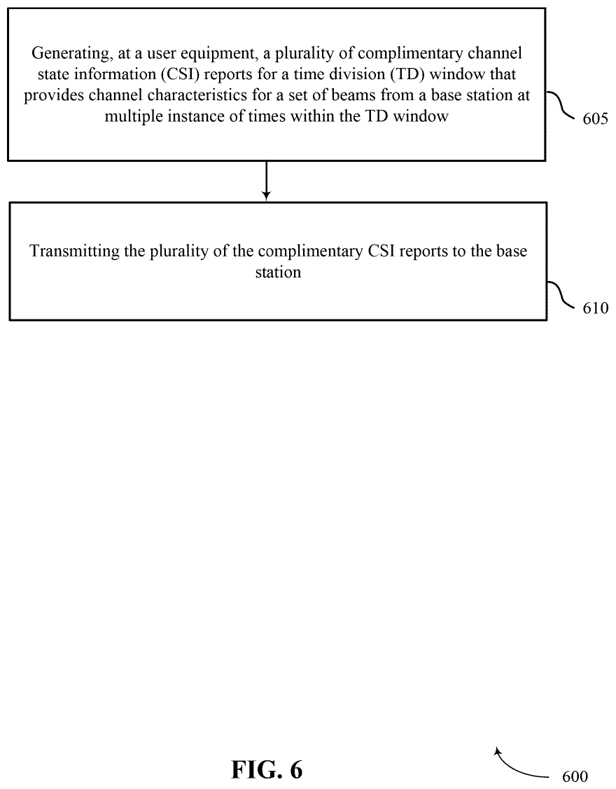

Referring to FIG. 6, an example method 600 for wireless communications in accordance with aspects of the present disclosure may be performed by one or more UEs 104 discussed with reference to FIG. 1A. Although the method 600 is described below with respect to the elements of the UE 104, other components may be used to implement one or more of the steps described herein.

At block 605, the method 600 may include generating, at a UE, a plurality of complimentary CSI reports for a TD window that provides channel characteristics for a set of beams from a base station at multiple instances of times within the TD window. In some examples, the processor 512, the modem 514, the CSI report generation component 198 and/or one or more other components or subcomponents of the UE 104 may perform the method of block 605.

In certain implementations, the processor 512, the modem 514, the CSI report generation component 198 in and/or one or more other components or subcomponents of the UE 104 may be configured to and/or may define means for generating, at a UE, a plurality of complimentary CSI reports for a TD window that provides channel characteristics for a set of beams from a base station at multiple instances of times within the TD window.

At block 610, the method 600 may include transmitting the plurality of the complimentary CSI reports to the base station. In some examples, the processor 512, the modem 514, the CSI report generation component 198 and/or one or more other components or subcomponents of the UE 104 may perform the method of block 605.

In certain implementations, the processor 512, the modem 514, the CSI report generation component 198 in and/or one or more other components or subcomponents of the UE 104 may be configured to and/or may define means for transmitting the plurality of the complimentary CSI reports to the base station.

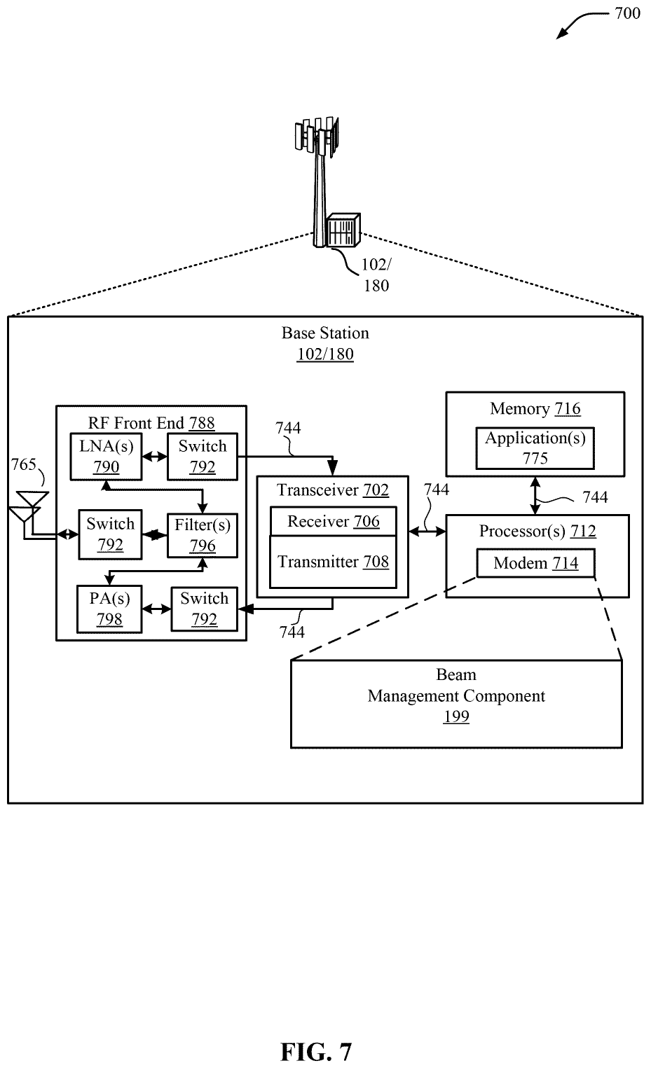

FIG. 7 illustrates a hardware components and subcomponents of a device that may be a base station 102/180 for implementing one or more methods (e.g., method 800) described herein in accordance with various aspects of the present disclosure. The base station 102/180 may be an example of base station 102/180 disclosed with reference to FIG. 1A. For example, one example of an implementation of the base station 102/180 may include a variety of components, some of which have already been described above, but including components such as one or more processors 712, memory 716 and transceiver 702 in communication via one or more buses 744, which may operate in conjunction with the beam management component 199 to perform functions described herein related to including one or more methods (e.g., 700) of the present disclosure.

Particularly, the beam management component 199 may receive the P/SP CSI-reports from the UE at the conclusion of each TD windows. In addition, the beam management component 199 may receive (or request) one or more complimentary L1 reports that measure the channel state of the set of beams within the past TD window. The beam management component 199 may utilize the one or more complimentary L1 reports to assist the base station AI/ML-based beam management system improve the confidence level of the beam prediction model.

The one or more processors 712, modem 714, memory 716, transceiver 702, RF front end 788 and one or more antennas 765, may be configured to support voice and/or data calls (simultaneously or non-simultaneously) in one or more radio access technologies. In an aspect, the one or more processors 712 can include a modem 714 that uses one or more modem processors. The various functions related to beam management component 199 may be included in modem 714 and/or processors 712 and, in an aspect, can be executed by a single processor, while in other aspects, different ones of the functions may be executed by a combination of two or more different processors. For example, in an aspect, the one or more processors 712 may include any one or any combination of a modem processor, or a baseband processor, or a digital signal processor, or a transmit processor, or a receiver processor, or a transceiver processor associated with transceiver 702. In other aspects, some of the features of the one or more processors 712 and/or modem 714 associated with beam management component 199 may be performed by transceiver 702.

The memory 716 may be configured to store data used herein and/or local versions of application(s) 775 or beam management component 199 and/or one or more of its subcomponents being executed by at least one processor 712. The memory 716 can include any type of computer-readable medium usable by a computer or at least one processor 712, such as random access memory (RAM), read only memory (ROM), tapes, magnetic discs, optical discs, volatile memory, non-volatile memory, and any combination thereof. In an aspect, for example, the memory 716 may be a non-transitory computer-readable storage medium that stores one or more computer-executable codes defining beam management component 199 and/or one or more of its subcomponents, and/or data associated therewith, when the base station 102/180 is operating at least one processor 712 to execute beam management component 199 and/or one or more of its subcomponents.

The transceiver 702 may include at least one receiver 706 and at least one transmitter 708. The receiver 706 may include hardware, firmware, and/or software code executable by a processor for receiving data, the code comprising instructions and being stored in a memory (e.g., computer-readable medium). The receiver 706 may be, for example, a radio frequency (RF) receiver. In an aspect, the receiver 706 may receive signals transmitted by at least one UE 104. Additionally, receiver 706 may process such received signals, and also may obtain measurements of the signals, such as, but not limited to, Ec/Io, SNR, RSRP, RSSI, etc. The transmitter 708 may include hardware, firmware, and/or software code executable by a processor for transmitting data, the code comprising instructions and being stored in a memory (e.g., computer-readable medium). A suitable example of the transmitter 708 may including, but is not limited to, an RF transmitter.

Moreover, in an aspect, transmitting device may include the RF front end 788, which may operate in communication with one or more antennas 765 and transceiver 702 for receiving and transmitting radio transmissions, for example, wireless communications transmitted by at least one UE 104. The RF front end 788 may be connected to one or more antennas 765 and can include one or more low-noise amplifiers (LNAs) 790, one or more switches 792, one or more power amplifiers (PAs) 798, and one or more filters 796 for transmitting and receiving RF signals.

In an aspect, the LNA 790 can amplify a received signal at a desired output level. In an aspect, each LNA 790 may have a specified minimum and maximum gain values. In an aspect, the RF front end 788 may use one or more switches 792 to select a particular LNA 790 and its specified gain value based on a desired gain value for a particular application.

Further, for example, one or more PA(s) 798 may be used by the RF front end 788 to amplify a signal for an RF output at a desired output power level. In an aspect, each PA 798 may have specified minimum and maximum gain values. In an aspect, the RF front end 788 may use one or more switches 792 to select a particular PA 798 and its specified gain value based on a desired gain value for a particular application.

Also, for example, one or more filters 796 can be used by the RF front end 758 to filter a received signal to obtain an input RF signal. Similarly, in an aspect, for example, a respective filter 796 can be used to filter an output from a respective PA 598 to produce an output signal for transmission. In an aspect, each filter 496 can be connected to a specific LNA 790 and/or PA 798. In an aspect, the RF front end 588 can use one or more switches 792 to select a transmit or receive path using a specified filter 796, LNA 90, and/or PA 798, based on a configuration as specified by the transceiver 702 and/or processor 712.

As such, the transceiver 702 may be configured to transmit and receive wireless signals through one or more antennas 65 via the RF front end 788. In an aspect, the transceiver 702 may be tuned to operate at specified frequencies such that transmitting device can communicate with, for example, one or more UEs 104. In an aspect, for example, the modem 714 can configure the transceiver 702 to operate at a specified frequency and power level based on the configuration of the transmitting device and the communication protocol used by the modem 714.

In an aspect, the modem 714 can be a multiband-multimode modem, which can process digital data and communicate with the transceiver 702 such that the digital data is sent and received using the transceiver 702. In an aspect, the modem 714 can be multiband and be configured to support multiple frequency bands for a specific communications protocol. In an aspect, the modem 714 can be multimode and be configured to support multiple operating networks and communications protocols. In an aspect, the modem 714 can control one or more components of transmitting device (e.g., RF front end 788, transceiver 702) to enable transmission and/or reception of signals from the network based on a specified modem configuration. In an aspect, the modem configuration can be based on the mode of the modem 714 and the frequency band in use. In another aspect, the modem configuration can be based on UE configuration information associated with transmitting device as provided by the network during cell selection and/or cell reselection.

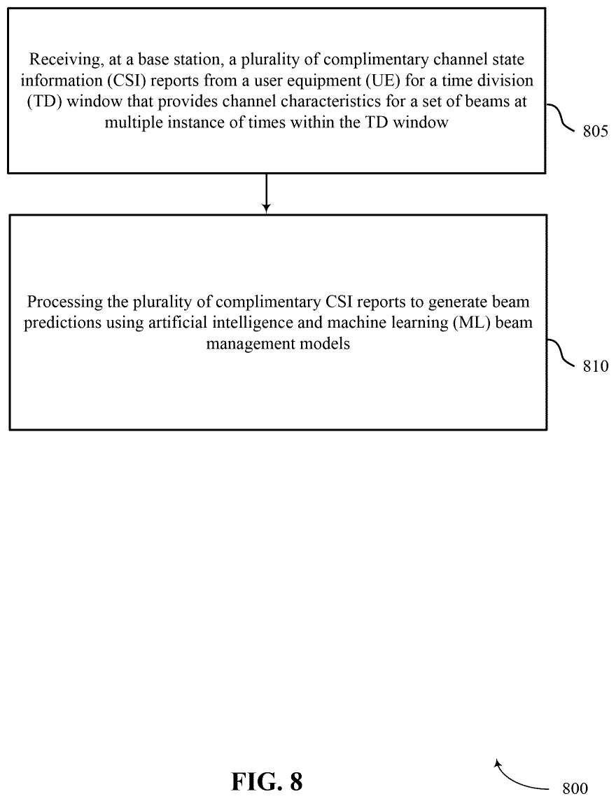

Referring to FIG. 8, an example method 800 for wireless communications in accordance with aspects of the present disclosure may be performed by one or more base station 102/180 discussed with reference to FIG. 1A. Although the method 800 is described below with respect to the elements of the base station 102/180, other components may be used to implement one or more of the steps described herein.

At block 805, the method 800 may include receiving, at a base station, a plurality of complimentary channel state information (CSI) reports from a user equipment (UE) for a time division (TD) window that provides channel characteristics for a set of beams at multiple instance of times within the TD window. In some examples, the complimentary CSI reports supplement a P/SP CSI report that may be received at the end of the TD window. The plurality of complimentary CSI reports may provide a greater channel characteristic granularity information within the TD window than the P/SP CSI report.

In some examples, each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window. In some examples, each complimentary CSI report from the plurality of complimentary CSI reports includes a TD variance information that is based on a differential power level values between a first reference signal received power (RSRP) and a second RSRP. The second RSRP may be associated with a periodic or semi-periodic CSI report received at the base station.

The method of block 805 may be performed by the beam management component 199, processor 712, the modem 714, and the transceiver 702 of the base station 102 described with reference to FIG. 7 above. In some examples, the combination of the beam management component 199, processor 712, the modem 714, and the transceiver 702 may be configured to perform the means for receiving, at a base station, a plurality of complimentary channel state information (CSI) reports from a user equipment (UE) for a time division (TD) window that provides channel characteristics for a set of beams at multiple instance of times within the TD window.

In some examples, each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation. In some examples, each complimentary CSI report from the plurality of complimentary CSI reports may be received at the base station is carried by uplink medium access control-control element (MAC-CE) or uplink control information (UCI).

At block 810, the method 800 may include processing the plurality of complimentary CSI reports to generate beam predictions using artificial intelligence (AI) and machine learning (ML) beam management models. The method of block 810 may be performed by the beam management component 199, processor 712, and the modem 714 of the base station 102 described with reference to FIG. 7 above. In some examples, the combination of the beam management component 199, processor 712, and the modem 714 may be configured to perform the means for processing the plurality of complimentary CSI reports to generate beam predictions using artificial intelligence (AI) and machine learning (ML) beam management models.

### SOME FURTHER EXAMPLE CLAUSES

Implementation examples are described in the following numbered clauses:
1. A method for wireless communication, comprising:
   receiving, at a base station, a plurality of complimentary channel state information (CSI) reports from a user equipment (UE) for a time division (TD) window that provides channel characteristics for a set of beams at multiple instance of times within the TD window; and
   processing the plurality of complimentary CSI reports to generate beam predictions using artificial intelligence (AI) and machine learning (ML) beam management models.
2. The method of clause 1, wherein the plurality of complimentary CSI reports supplement a periodic or semi-periodic CSI report that is received at end of the TD window,
   wherein the plurality of complimentary CSI reports provide a greater channel characteristic granularity information within the TD window than the periodic or semi-periodic CSI report.
3. The method of any of the preceding clauses, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.
4. The method of any of the preceding clauses, wherein each complimentary CSI report from the plurality of complimentary CSI reports includes a TD variance information that is based on a differential power level values between a first reference signal received power (RSRP) and a second RSRP,
   wherein the second RSRP is associated with a periodic or semi-periodic CSI report received at the base station.
5. The method of any of the preceding clauses, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.
6. The method of any of the preceding clauses, wherein each complimentary CSI report from the plurality of complimentary CSI reports received at the base station is carried by uplink medium access control-control element (MAC-CE) or uplink control information (UCI).
7. An apparatus for wireless communication, comprising:
   a memory including instructions; and
   a processor coupled with the memory to execute the instructions and configured to:
      receive, at a base station, a plurality of complimentary channel state information (CSI) reports from a user equipment (UE) for a time division (TD) window that provides channel characteristics for a set of beams at multiple instance of times within the TD window; and
      process the plurality of complimentary CSI reports to generate beam predictions using artificial intelligence (AI) and machine learning (ML) beam management models.
8. The apparatus of clause 7, wherein the plurality of complimentary CSI reports supplement a periodic or semi-periodic CSI report that is received at end of the TD window,
   wherein the plurality of complimentary CSI reports provide a greater channel characteristic granularity information within the TD window than the periodic or semi-periodic CSI report.
9. The apparatus of any of the preceding clauses, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.
10. The apparatus of any of the preceding clauses, wherein each complimentary CSI report from the plurality of complimentary CSI reports includes a TD variance information that is based on a differential power level values between a first reference signal received power (RSRP) and a second RSRP,
   wherein the second RSRP is associated with a periodic or semi-periodic CSI report received at the base station.
11. The apparatus of any of the preceding clauses, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.
12. The apparatus of any of the preceding clauses, wherein each complimentary CSI report from the plurality of complimentary CSI reports received at the base station is carried by uplink medium access control-control element (MAC-CE) or uplink control information (UCI).
13. A method for wireless communication, comprising:
   generating, at a user equipment (UE), a plurality of complimentary channel state information (CSI) reports for a time division (TD) window that provides channel characteristics for a set of beams from a base station at multiple instance of times within the TD window; and
   transmitting the plurality of the complimentary CSI reports to the base station.
14. The method of clause 13, wherein the plurality of complimentary CSI reports supplement a periodic or semi-periodic CSI report that is transmitted at end of the TD window,
   wherein the plurality of complimentary CSI reports provide a greater channel characteristic granularity information within the TD window than the periodic or semi-periodic CSI report.
15. The method of any of the preceding clauses, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.
16. The method of any of the preceding clauses, wherein each complimentary CSI report from the plurality of complimentary CSI reports includes a TD variance information that is based on a differential power level values between a first reference signal received power (RSRP) and a second RSRP,
   wherein the second RSRP is associated with a periodic or semi-periodic CSI report transmitted to the base station.
17. The method of any of the preceding clauses, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.
18. The method of any of the preceding clauses, wherein each complimentary CSI report from the plurality of complimentary CSI reports transmitted to the base station are carried by uplink medium access control-control element (MAC-CE) or uplink control information (UCI).
19. An apparatus for wireless communication, comprising:
   a memory including instructions; and
   a processor coupled with the memory to execute the instructions and configured to:
   generate, at a user equipment (UE), a plurality of complimentary channel state information (CSI) reports for a time division (TD) window that provides channel characteristics for a set of beams from a base station at multiple instance of times within the TD window; and
   transmit the plurality of the complimentary CSI reports to the base station.
20. The apparatus of clause 19, wherein the plurality of complimentary CSI reports supplement a periodic or semi-periodic CSI report that is transmitted at end of the TD window,
   wherein the plurality of complimentary CSI reports provide a greater channel characteristic granularity information within the TD window than the periodic or semi-periodic CSI report.
21. The apparatus of any of the preceding clauses, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.
22. The apparatus of any of the preceding clauses, wherein each complimentary CSI report from the plurality of complimentary CSI reports includes a TD variance information that is based on a differential power level values between a first reference signal received power (RSRP) and a second RSRP,
   wherein the second RSRP is associated with a periodic or semi-periodic CSI report transmitted to the base station.
23. The apparatus of any of the preceding clauses, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.
24. The apparatus of any of the preceding clauses, wherein each complimentary CSI report from the plurality of complimentary CSI reports transmitted to the base station are carried by uplink medium access control-control element (MAC-CE) or uplink control information (UCI).

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication, comprising:
receiving, at a base station, a plurality of complimentary channel state information (CSI) reports from a user equipment (UE) for a time division (TD) window that provides channel characteristics for a set of beams at multiple instance of times within the TD window; and
processing the plurality of complimentary CSI reports to generate beam predictions using artificial intelligence (AI) and machine learning (ML) beam management models.

2. The method of claim 1, wherein the plurality of complimentary CSI reports supplement a periodic or semi-periodic CSI report that is received at end of the TD window,
wherein the plurality of complimentary CSI reports provide a greater channel characteristic granularity information within the TD window than the periodic or semi-periodic CSI report.

3. The method of claim 1, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.

4. The method of claim 1, wherein each complimentary CSI report from the plurality of complimentary CSI reports includes a TD variance information that is based on a differential power level values between a first reference signal received power (RSRP) and a second RSRP,
wherein the second RSRP is associated with a periodic or semi-periodic CSI report received at the base station.

5. The method of claim 1, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.

6. The method of claim 1, wherein each complimentary CSI report from the plurality of complimentary CSI reports received at the base station is carried by uplink medium access control-control element (MAC-CE) or uplink control information (UCI).

7. An apparatus for wireless communication, comprising:
a memory including instructions; and
a processor coupled with the memory to execute the instructions and configured to:
receive, at a base station, a plurality of complimentary channel state information (CSI) reports from a user equipment (UE) for a time division (TD) window that provides channel characteristics for a set of beams at multiple instance of times within the TD window; and
process the plurality of complimentary CSI reports to generate beam predictions using artificial intelligence (AI) and machine learning (ML) beam management models.

8. The apparatus of claim 7, wherein the plurality of complimentary CSI reports supplement a periodic or semi-periodic CSI report that is received at end of the TD window,
wherein the plurality of complimentary CSI reports provide a greater channel characteristic granularity information within the TD window than the periodic or semi-periodic CSI report.

9. The apparatus of claim 7, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.

10. The apparatus of claim 7, wherein each complimentary CSI report from the plurality of complimentary CSI reports includes a TD variance information that is based on a differential power level values between a first reference signal received power (RSRP) and a second RSRP,
wherein the second RSRP is associated with a periodic or semi-periodic CSI report received at the base station.

11. The apparatus of claim 7, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.

12. The apparatus of claim 7, wherein each complimentary CSI report from the plurality of complimentary CSI reports received at the base station is carried by uplink medium access control-control element (MAC-CE) or uplink control information (UCI).

13. A method for wireless communication, comprising:
generating, at a user equipment (UE), a plurality of complimentary channel state information (CSI) reports for a time division (TD) window that provides channel characteristics for a set of beams from a base station at multiple instance of times within the TD window; and
transmitting the plurality of the complimentary CSI reports to the base station.

14. The method of claim 13, wherein the plurality of complimentary CSI reports supplement a periodic or semi-periodic CSI report that is transmitted at end of the TD window, wherein the plurality of complimentary CSI reports provide a greater channel characteristic granularity information within the TD window than the periodic or semi-periodic CSI report.

15. The method of claim 13, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.

16. The method of claim 13, wherein each complimentary CSI report from the plurality of complimentary CSI reports includes a TD variance information that is based on a differential power level values between a first reference signal received power (RSRP) and a second RSRP,
wherein the second RSRP is associated with a periodic or semi-periodic CSI report transmitted to the base station.

17. The method of claim 13, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.

18. The method of claim 13, wherein each complimentary CSI report from the plurality of complimentary CSI reports transmitted to the base station are carried by uplink medium access control-control element (MAC-CE) or uplink control information (UCI).

19. An apparatus for wireless communication, comprising:
a memory including instructions; and
a processor coupled with the memory to execute the instructions and configured to:
generate, at a user equipment (UE), a plurality of complimentary channel state information (CSI) reports for a time division (TD) window that provides channel characteristics for a set of beams from a base station at multiple instance of times within the TD window; and
transmit the plurality of the complimentary CSI reports to the base station.

20. The apparatus of claim 19, wherein the plurality of complimentary CSI reports supplement a periodic or semi-periodic CSI report that is transmitted at end of the TD window,
wherein the plurality of complimentary CSI reports provide a greater channel characteristic granularity information within the TD window than the periodic or semi-periodic CSI report.

21. The apparatus of claim 19, wherein each complimentary CSI report from the plurality of complimentary CSI reports includes a measured reference signal received power (RSRP) or signal to noise ratio (SINR) associated with CSI reference signals or synchronization signal blocks (SSBs) regarding multiple time occasions within the TD window.

22. The apparatus of claim 19, wherein each complimentary CSI report from the plurality of complimentary CSI reports includes a TD variance information that is based on a differential power level values between a first reference signal received power (RSRP) and a second RSRP,
wherein the second RSRP is associated with a periodic or semi-periodic CSI report transmitted to the base station.

23. The apparatus of claim 19, wherein each complimentary CSI report from the plurality of complimentary CSI reports further indicate whether multiple CSI reference signals or synchronization signal blocks (SSBs) have a certain level of correlation in terms of reference signal received power (RSRP) or signal to noise ratio (SINR) fluctuation.

24. The apparatus of claim 19, wherein each complimentary CSI report from the plurality of complimentary CSI reports transmitted to the base station are carried by uplink medium access control-control element (MAC-CE) or uplink control information (UCI).
